(19) United States
(12) Patent Application Publication
(10) Pub. No.: US 2023/0301268 A1
(43) Pub. Date: Sep. 28, 2023

(54) CLUMPED CAT LITTER FILTER DEVICE AND FILTERING METHOD THEREOF

(71) Applicant: Xiaojun ZHANG, Shenzhen (CN)

(72) Inventor: Xiaojun ZHANG, Shenzhen (CN)

(21) Appl. No.: 18/072,726

(22) Filed: Dec. 1, 2022

(30) Foreign Application Priority Data
Mar. 22, 2022 (CN) 202210279926.3

(51) Int. Cl. A01K 1/01

(52) U.S. Cl. CPC A01K 1/0114

(57) ABSTRACT

A clumped cat litter filter device and a filtering method thereof are provided. The filter device includes a litter box including a body with a receiving room and a collecting room thereof, a soft cushion, a separating rod transversely arranged between the soft cushion and the bottom wall of the receiving room, and moving along a length direction of the body, a filtering shovel transversely placed above the soft cushion along a width direction of the collecting room, a moving member configured to drive the separating rod and the filtering shovel to move along the length direction of the body, a rotating member installed on the moving member; the present disclosure can prevent the filtering shovel from crushing clumped cat litter, improve a filtering effect thereof, adapt to a variety of cat litter, reduce odor, have advantages of a small size, a low cost, low operation noise and high safety.

### BACKGROUND

### 1. Technical Field

The present disclosure generally relates to the technical field of devices for collecting animal excrement, and especially relates to a clumped cat litter filter device and a filtering method thereof.

### 2. Description of Related Art

At present, a cat automatic toilet with an automatic cleaning function has been gradually used in the market. A filter device for filtering clumped cat litter is a core structure of the cat automatic toilet, currently, two modes such as rotating a litter bin and moving a cat litter shovel for filtering the clumped cat litter are most widely used.

A basic principle of the filtering mode by rotating the litter bin is to drive the litter bin to rotate by an external force, and then drive a filter screen in the litter bin to filter the clumped cat litter, which has a good filtering effect and a small odor, and the clumped cat litter is not easy to be crushed; however, such filtering mode has problems of a complex structure, a great volume, a high cost, and a certain potential safety hazards for pets.

The filter mode by rotating the cat litter shovel is that the cat litter shovel (filter screen) is driven by the external force to move or rotate in the cat litter along a horizontal direction and a vertical direction to filter the clumped cat litter from the cat litter, which has a simple structure, a small volume, a low cost and a high safety for pets; however, this mode has disadvantages: when the clumped cat litter is stuck at the bottom of the litter box, or when the clumped cat litter is buried in the cat litter, the clumped cat litter is easy to be crushed by the litter shovel that has moved, resulting in unclean filtration of the cat litter or attachment to the cat litter shovel.

### SUMMARY

The technical problems to be solved: in view of the shortcomings of the related art, an object of the present disclosure is to provide a clumped cat litter filter device and a filtering method thereof which can provide a separating rod and an independent rotating member for rotating a litter shovel thereof, so as to actively separate clumped cat litter that is glued to a bottom of a litter box from the bottom of the litter box through the separating rod, and then transfer the clumped cat litter that has been separated by the independent rotating member.

Another object of the present disclosure is to provide the clumped cat litter filtering device, which can simulate to manually filter the clumped cat litter, and significantly reduce a phenomenon that the clumped cat litter is crushed or adhered to a litter shovel thereof.

The technical solution adopted for solving technical problems of the present disclosure is: a clumped cat litter filter device according to an embodiment of the present disclosure includes:
a litter box including a body and a soft cushion, the body including a receiving room for receiving cat litter, and a collecting room arranged adjacent to the receiving room and configured to collect clumped cat litter, the soft cushion arranged on a bottom wall of the receiving room;
a separating rod transversely arranged between the soft cushion and the bottom wall of the receiving room, and moving along a length direction of the body; wherein a part of the soft cushion that is in contact with the separating rod is bulged upwardly by the separating rod during moving the separating rod;
a filtering shovel configured to filter the clumped cat litter and transversely placed inside the receiving room and above the soft cushion, turning over at front and back ends of the receiving room along a length direction of the receiving room, and moving along the length direction of the receiving room;
a moving member configured to drive both the separating rod and the filtering shovel to move along the length direction of the receiving room, and including a first sliding block, a second sliding block opposite to the first sliding block, and a driving member connected to both the first and second sliding blocks, the first sliding block and the second sliding block slidably arranged on the body, respectively, so that the driving member drives the first and second sliding blocks to synchronously move back and forth along the length direction of the body, and both a head and a tail of the separating rod are connected with the first sliding block and the second sliding block, respectively; and
a rotating member installed on the first sliding block and configured to drive the filtering shovel to turn over in the receiving room; the rotating member including a rotating arm and a rotating portion connected with the rotating arm and driving the rotating arm to rotate, the rotating arm rotatably installed between the first sliding block and the second sliding block, the rotating portion installed on the first sliding block and in transmission connection with the rotating arm, and the filtering shovel arranged inside the receiving room and fixedly connected with the rotating arm.

Wherein the soft cushion includes flanks extending from four sides thereof and in contact with corresponding side walls of the receiving room.

Wherein the body is surrounded by a front plate, a back plate, a left plate, a right plate and a bottom plate, and a spacer is arranged between the left plate and the right plate so that the body is divided into the receiving room and the collecting room by the spacer.

Wherein the driving member includes a traveling motor and two sliding pairs, one of the two sliding pairs arranged between the head of the separating rod and the body, and the other of the two sliding pairs arranged between the tail of the separating rod and the body; each of the two sliding pairs including a rack arranged on the body, and a gear sleeved around the separating rod and engaged with the rack, the traveling motor fixed on the first sliding block and connected with the gear that is arranged on the same side of the rack, so that when the traveling motor rotates, the traveling motor drives the gear that is connected with the traveling motor to move on the rack that is formed on the same side of the traveling motor.

Wherein the rotating portion includes an annular rack, a driving gear engaged with the annular rack, a rotating motor connected with the driving gear, and a linkage member connected with the rotating arm and the rotating motor, respectively, the rotating motor driving the driving gear to move on the annular rack, so that the linkage member drives the rotating arm to rotate between the first sliding block and the second sliding block, and the rotating arm drives the filtering shovel to turn over at the front and back ends along the length direction of the receiving room.

Wherein the filtering shovel is composed of a plurality of rods arranged adjacent thereof in turn.

A filter method for filtering clumped cat litter according to an embodiment of the present disclosure includes the following steps:
a first step, providing a clumped cat litter filter device that includes a litter box, a separating rod and a filtering shovel; the litter box including a body and a soft cushion, the body including a receiving room for receiving cat litter, and a collecting room arranged adjacent to the receiving room and configured to collect clumped cat litter, the soft cushion arranged on a bottom wall of the receiving room; the separating rod transversely arranged between the soft cushion and the bottom wall of the receiving room, and moving along a length direction of the body; wherein a part of the soft cushion contacting with the separating rod is bulged upwardly by the separating rod during moving the separating rod;
a second step, when there is clumped cat litter stuck on the soft cushion at a position of the receiving room, moving both the filtering shovel and the separating rod a distance L1 along the length direction of the receiving room synchronously, to separate the clumped cat litter from the soft cushion by the separating rod raising the soft cushion upwards, and separate the clumped cat litter from un-clumped cat litter by the filtering shovel;
a third step, rotating the filtering shovel to shovel the clumped cat litter in the second step to an upper layer of the un-clumped cat litter and then stopping rotating the filtering shovel;
a fourth step, moving both the filtering shovel and the separating rod back a distance L2 along a moving direction in the second step, and then rotating the filtering shovel back to an initial position and stopping rotating the filtering shovel;
a fifth step, repeating the above second, third and fourth steps until the filtering shovel reaches a limit position thereof, and then rotating the filtering shovel to a horizontal position thereof, collecting all the clumped cat litter stacked on the upper layer of the un-clumped cat litter to the filtering shovel, and completing a filtration process of the clumped cat litter; and
a sixth step, moving the filtering shovel with the clumped cat litter back to a side of the collecting room, and continuing to rotate the filtering shovel until the clumped cat litter on the filtering shovel is transferred to the collecting room.

Wherein an average length of the cat litter is less than the distance L1, the distance L1 less than 10 times of the average length of the cat litter, and the distance L2 less than the distance L1.

Wherein a moving member drives both the filtering shovel and the separating rod to move along the length direction of the receiving room.

Wherein the filtering shovel is driven by a rotating member that is installed on the moving member to turn over at both front and back ends thereof along the length direction of the receiving room.

The present disclosure provides the advantages as below: the present disclosure can prevent the filtering shovel from crushing the clumped cat litter, improve a filtering effect of the clumped cat litter, adapt to a variety of cat litter including strip cat litter, reduce odor, and have advantages of a small size, a low cost, low operation noise, and high safety of filtering the cat litter.

### BRIEF DESCRIPTION OF THE DRAWINGS

FIG. 1 is a schematic view of a clumped cat litter filter device in accordance with an embodiment of the present disclosure.

FIG. 2 is a cross section view of the filter device along a length direction of the filter device of FIG. 1.

FIG. 3 is a cross section view along a first sliding block of the filter device of FIG. 1.

FIG. 4 is a cross section view along a second sliding block of the filter device of FIG. 1.

FIG. 5 is a cross section view along a width direction of the filter device of FIG. 1.

FIG. 6 is a schematic view of a rotating member of the litter filter device of FIG. 1.

FIG. 7 is similar to FIG. 1, but shown from another view.

### DETAILED DESCRIPTION

Reference will now be made in detail to embodiments, examples of which are illustrated in the accompanying drawings. In the following detailed description, numerous specific details are set forth in order to provide a thorough understanding of the subject matter presented herein. Obviously, the implementation embodiment in the description is a part of the present disclosure implementation examples, rather than the implementation of all embodiments, examples. According to the described embodiment of the present disclosure, all other embodiments obtained by one of ordinary skill in the related art on the premise of no creative work are within the protection scope of the present disclosure.

It should be noted that when one component is described “fixed to” or “arranged to” the other component, it can be directly or indirectly set on the other component. When one component is described to be “connected to” the other component, it can be directly connected to the other component or indirectly connected to the other component.

In the description of the present disclosure, it needs to be explained that all the directional indicators (such as the terms: “length”, “width”, “upper”, “below”, “front”, “back”, “left”, “right”, “vertical”, “horizontal”, “top”, “bottom”, “inside”, “outside” . . . ), are shown in the specification of the present disclosure. The indicated orientation or position of the terms shown in the detailed description is based on the orientation or position shown in the figures of the accompanying drawings of the present disclosure, which is only to easily simplify the description of the present disclosure, but not indicated that the devices or members of the present disclosure should have a particular orientation or should be designed and operated in a particular orientation. So the terms illustrated in the detail description are not by way of the limitation of the present disclosure.

Furthermore, in the description of the present disclosure, the terms such as “first” and “second” shown in the specification are only used to describe, but not indicated that the members of the present disclosure is important or represented the amount of the members. That is, the features limited by the terms of “first” and “second” may explicitly or implicitly include one or more features. In the description of the present disclosure, “a plurality of” means two or more, unless otherwise specifically defined.

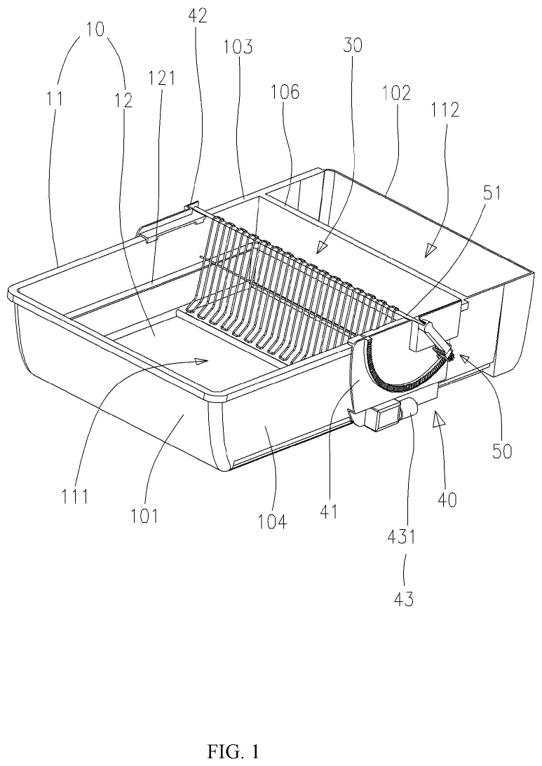

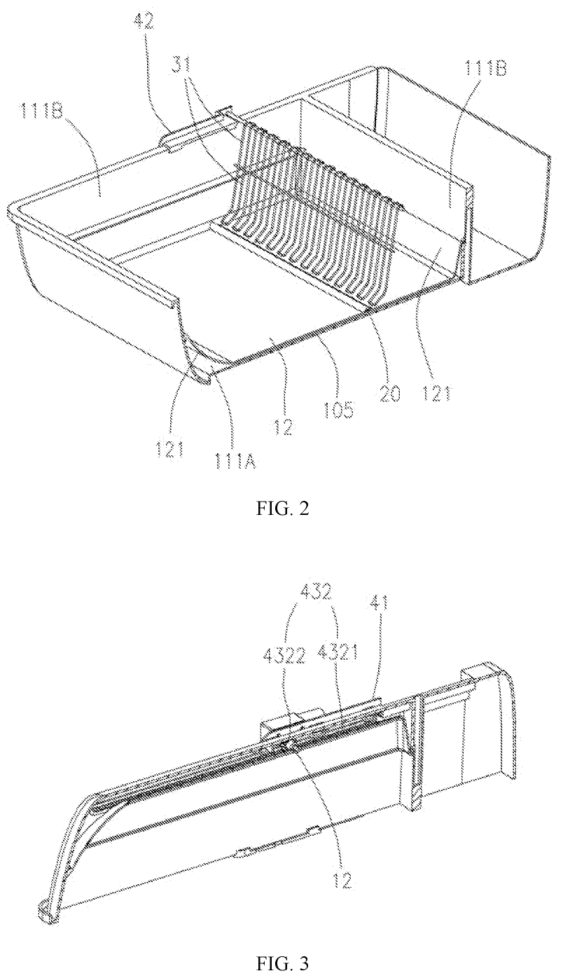

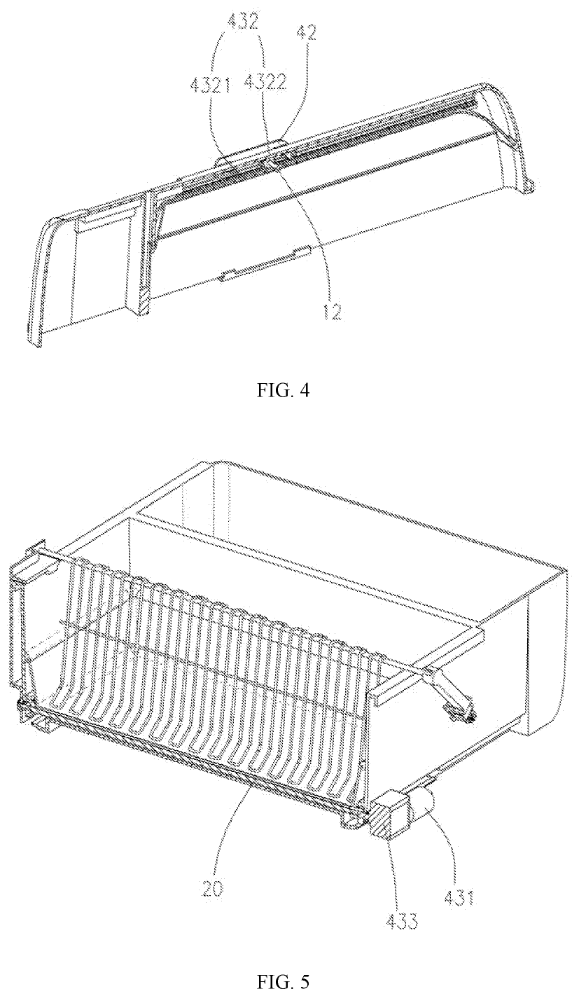

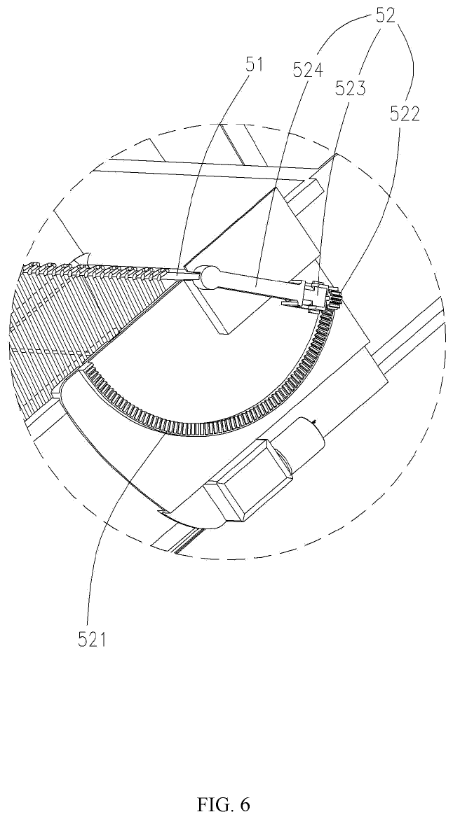

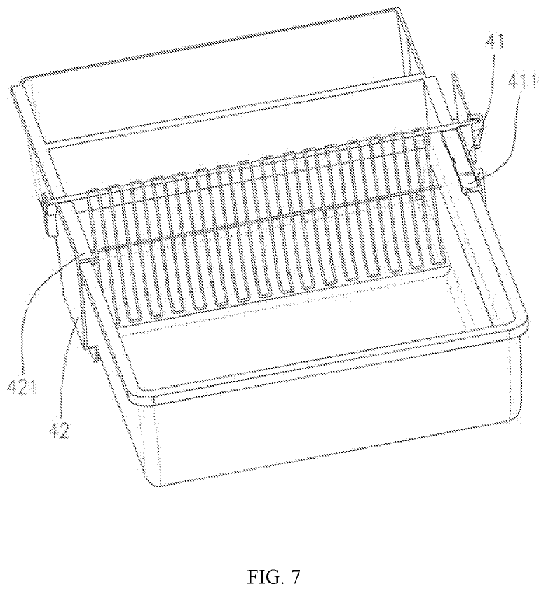

Referring to FIGS. 1-7, a clumped cat litter filter device in accordance with an embodiment of the present disclosure includes:
a litter box 10 configured to receive cat litter for pets such as cats or dogs to enter therein for excreting feces, and including a body 11 and a soft cushion 12 received in the body 11, the body 11 including a receiving room 111 for receiving the cat litter and a collecting room 112 arranged adjacent to the receiving room 111 and configured to collect the clumped cat litter, the soft cushion 12 arranged on a bottom wall 111A of the receiving room 111. The cat litter is placed on the soft cushion 12. The collecting room 112 is configured to collect the clumped cat litter. Flanks 121 extend from four sides of the soft cushion 12 and are in contact with corresponding side walls 111B of the receiving room 111, so that the cat litter can be supported by the soft cushion 12. The soft cushion 12 is made of soft materials, such as silicone, rubber and other materials with waterproof performances and good softness. The body 11 is surrounded by a front plate 101, a back plate 102, a left plate 103, a right plate 104 and a bottom plate 105, and a spacer 106 is arranged between the left plate 103 and the right plate 104 so that the body 11 is divided into the receiving room 111 and the collecting room 112 by the spacer 106;
a separating rod 20 transversely arranged between the soft cushion 12 and the bottom wall 111A of the receiving room 111, and moving along a length direction of the body 11; a part of the soft cushion 12 in contact with the separating rod 20 is bulged upwardly by the separating rod 20 during moving the separating rod 20, so as to separate the clumped cat litter that has stuck on the soft cushion 12 from the soft cushion 12;
a filtering shovel 30 transversely placed inside the receiving room 111 and above the soft cushion 12, turning over at front and back ends of the receiving room 111 along a length direction of the receiving room 111, and moving along the length direction of the receiving room 111; the filtering shovel 30 is composed of a plurality of rods 31 arranged adjacent thereof in turn;
a moving member 40 configured to drive both the separating rod 20 and the filtering shovel 30 to move along the length direction of the receiving room 111, and including a first sliding block 41, a second sliding block 42 opposite to the first sliding block 41, and a driving member 43 connected to both the first and second sliding blocks 41, 42; the first sliding block 41 and the second sliding block 42 slidably arranged on the body 11, respectively, so that the driving member 43 drives the first and second sliding blocks 41, 42 to synchronously move back and forth along the length direction of the body 11, and both a head and a tail of the separating rod 20 are connected with the first sliding block 41 and the second sliding block 42, respectively; the driving member 43 includes a traveling motor 431 and two sliding pairs 432, one of the two sliding pairs 432 arranged between the head of the separating rod 20 and the body 11, and the other of the two sliding pairs 432 arranged between the tail of the separating rod 20 and the body 11; each of the two sliding pairs 432 including a rack 4321 arranged on the body 11, and a gear 4322 sleeved around the separating rod 20 and engaged with the rack 4321, the traveling motor 431 fixed on the first sliding block 42 and connected with the gear 4322 that is arranged on the same side of the rack 4321. In an embodiment of the present disclosure, the traveling motor 431 is connected with the gear 4322 through a gear reduction set 433 that is connected with the traveling motor 431, so that when the traveling motor 431 rotates, the gear 4322 that is connected with the traveling motor 431 is driven to move along the rack 4321 that has engaged with the gear 4322; as long as the traveling motor 431 drives one gear 4322 to move, the other gear 4322 can be driven to following moving through the separating rod 20, so that the first sliding block 41 and the second sliding block 42 can move along the length direction of the body 11. In an embodiment of the present disclosure, the separating rod 20 has functions of transmission and raising the soft cushion 12 when moving the separating rod 20. A part of the soft cushion 12 in contact with the separating rod 20 is bulged upwardly by the separating rod 20 during moving the separating rod 20; when the clumped cat litter is stuck on the soft cushion 12, the part that has been raised will gradually lift the clumped cat litter, to cause the clumped cat litter to separate from the soft cushion 12;
a rotating member 50 installed on the first sliding block 41 and configured to drive the filtering shovel 30 to turn over in the receiving room 111; the rotating member 50 including a rotating arm 51 and a rotating portion 52 connected with the rotating arm 51 and driving the rotating arm 51 to rotate, the rotating arm 51 rotatably installed between the first sliding block 41 and the second sliding block 42, the rotating portion 52 installed on the first sliding block 41 and in transmission connection with the rotating arm 51, and the filtering shovel 30 arranged inside the receiving room 111 and fixedly connected with the rotating arm 51; in this way, the rotating portion 52 drives the rotating arm 51 to rotate, so that the rotating arm 51 drives the filtering shovel 30 to turn back and forth along the length direction of the receiving room 111. The rotating portion 52 includes an annular rack 521, a driving gear 522 engaged with the annular rack 521, a rotating motor 523 connected with the driving gear 522, and a linkage member 524 connected with the rotating arm 521 and the rotating motor 523, respectively; the rotating motor 523 driving the driving gear 522 to move on the annular rack 521, so that the rotating motor 523 drives the rotating arm 51 to move along a moving direction of the driving gear 522, the linkage member 524 drives the rotating arm 521 to rotate between the first sliding block 41 and the second sliding block 42, and the rotating arm 521 drives the filtering shovel 30 to turn over at the front and back ends along the length direction of the receiving room 111.

In an embodiment of the present disclosure, the first sliding block 41 includes a first hanging plate 411, and the second sliding block 42 includes a second hanging plate 421. The first sliding block 41 is slidably suspended on the top of the left plate 103 of the body 11 through the first hanging plate 411, and the second sliding block 42 is slidably suspended on the top of the right plate 104 of the body 11 through the second hanging plate 421. The racks 4321 of the two moving pairs 432 are respectively arranged at the bottom of the left plate 103 and the right plate 104 of the body 11.

A filter method for filtering clumped cat litter according to an embodiment of the present disclosure includes the following steps:
a first step, providing a clumped cat litter filter device that includes a litter box, a separating rod and a filtering shovel, the litter box including a body and a soft cushion, the body including a receiving room for receiving cat litter, and a collecting room arranged adjacent to the receiving room and configured to collect clumped cat litter, the soft cushion arranged on the bottom wall of the receiving room; the separating rod transversely arranged between the soft cushion and the bottom wall of the receiving room, and moving along the length direction of the body; wherein a part of the soft cushion contacting with the separating rod is bulged upwardly by the separating rod during moving the separating rod;
a second step, when there is clumped cat litter stuck on the soft cushion at a position of the receiving room, moving both the filtering shovel and the separating rod a distance L1 along the length direction of the receiving room synchronously, to separate the clumped cat litter from the soft cushion by the separating rod raising the soft cushion upwards, and separate the clumped cat litter from un-clumped cat litter by the filtering shovel;
a third step, rotating the filtering shovel to shovel the clumped cat litter in the second step to an upper layer of the un-clumped cat litter and then stopping rotating the filtering shovel;
a fourth step, moving both the filtering shovel and the separating rod back a distance L2 along a moving direction in the second step, and then rotating the filtering shovel back to an initial position and stopping rotating the filtering shovel;
a fifth step, repeating the above second, third and fourth steps until the filtering shovel reaches a limit position thereof, and then rotating the filtering shovel to a horizontal position thereof, collecting all the clumped cat litter stacked on the upper layer of the un-clumped cat litter to the filtering shovel, and completing a filtration process of the clumped cat litter; and
a sixth step, moving the filtering shovel with the clumped cat litter back to a side of the collecting room, and continuing to rotate the filtering shovel until the clumped cat litter on the filtering shovel is transferred to the collecting room.

An average length of the cat litter is less than the distance L1, the distance L1 is less than 10 times of the average length of the cat litter, and the distance L2 is less than the distance L1.

Both the filtering shovel and the separating rod are driven by the moving member to move along the length direction of the receiving room. The filtering shovel is driven by the rotating member that is installed on the moving member to turn over at both front and back ends thereof along the length direction of the receiving room.

The embodiments and drawings of the present disclosure are only configured for showing a design concept of the present disclosure, and the protection scope of the present disclosure should not be limited to the above embodiment.

Although the features and members of the present disclosure are described as embodiments in particular combinations, each feature or member can be used alone or in other various combinations within the principles of the present disclosure to the full extent indicated by the broad general meaning of the terms in which the appended claims are expressed.

What is claimed is:

1. A clumped cat litter filter device comprising:
a litter box comprising a body and a soft cushion, the body comprising a receiving room for receiving cat litter, and a collecting room arranged adjacent to the receiving room and configured to collect clumped cat litter, the soft cushion arranged on a bottom wall of the receiving room;
a separating rod transversely arranged between the soft cushion and the bottom wall of the receiving room, and moving along a length direction of the body; wherein a part of the soft cushion that is in contact with the separating rod is bulged upwardly by the separating rod during moving the separating rod;
a filtering shovel configured to filter the clumped cat litter transversely placed inside the receiving room and above the soft cushion, turning over at front and back ends of the receiving room along a length direction of the receiving room, and moving along the length direction of the receiving room;
a moving member configured to drive both the separating rod and the filtering shovel to move along the length direction of the receiving room, and comprising a first sliding block, a second sliding block opposite to the first sliding block, and a driving member connected to both the first and second sliding blocks, the first sliding block and the second sliding block slidably arranged on the body, respectively, so that the driving member drives the first and second sliding blocks to synchronously move back and forth along the length direction of the body, and both a head and a tail of the separating rod are connected with the first sliding block and the second sliding block, respectively; and
a rotating member installed on the first sliding block and configured to drive the filtering shovel to turn over in the receiving room; the rotating member comprising a rotating arm and a rotating portion connected with the rotating arm and driving the rotating arm to rotate, the rotating arm rotatably installed between the first sliding block and the second sliding block, the rotating portion installed on the first sliding block and in transmission connection with the rotating arm, and the filtering shovel arranged inside the receiving room and fixedly connected with the rotating arm.

2. The filter device as claimed in claim 1, wherein the soft cushion comprises flanks extending from four sides thereof and in contact with corresponding side walls of the receiving room.

3. The filter device as claimed in claim 1, wherein the body is surrounded by a front plate, a back plate, a left plate, a right plate and a bottom plate, and a spacer is arranged between the left plate and the right plate so that the body is divided into the receiving room and the collecting room by the spacer.

4. The filter device as claimed in claim 1, wherein the driving member comprises a traveling motor and two sliding pairs, one of the two sliding pairs arranged between the head of the separating rod and the body, and the other of the two sliding pairs arranged between the tail of the separating rod and the body; each of the two sliding pairs comprising a rack arranged on the body, and a gear sleeved around the separating rod and engaged with the rack, the traveling motor fixed on the first sliding block and connected with the gear that is arranged on the same side of the rack, so that when the traveling motor rotates, the traveling motor drives the gear that is connected with the traveling motor to move on the rack that is formed on the same side of the traveling motor.

5. The filter device as claimed in claim 1, wherein the rotating portion comprises an annular rack, a driving gear engaged with the annular rack, a rotating motor connected with the driving gear, and a linkage member connected with the rotating arm and the rotating motor, respectively, the rotating motor driving the driving gear to move on the annular rack, so that the linkage member drives the rotating arm to rotate between the first sliding block and the second sliding block, and the rotating arm drives the filtering shovel to turn over at the front and back ends along the length direction of the receiving room.

6. The filter device as claimed in claim 1, wherein the filtering shovel is composed of a plurality of rods arranged adjacent thereof in turn.

7. A filter method for filtering clumped cat litter comprising the following steps:
a first step, providing a clumped cat litter filter device that comprises a litter box, a separating rod and a filtering shovel, the litter box comprising a body and a soft cushion, the body comprising a receiving room for receiving cat litter, and a collecting room arranged adjacent to the receiving room and configured to collect clumped cat litter, the soft cushion arranged on a bottom wall of the receiving room; the separating rod transversely arranged between the soft cushion and the bottom wall of the receiving room, and moving along a length direction of the body; wherein a part of the soft cushion contacting with the separating rod is bulged upwardly by the separating rod during moving the separating rod;
a second step, when there is clumped cat litter stuck on the soft cushion at a position of the receiving room, moving both the filtering shovel and the separating rod a distance L1 along the length direction of the receiving room synchronously, to separate the clumped cat litter from the soft cushion by the separating rod raising the soft cushion upwards, and separate the clumped cat litter from un-clumped cat litter by the filtering shovel;
a third step, rotating the filtering shovel to shovel the clumped cat litter in the second step to an upper layer of the un-clumped cat litter and then stopping rotating the filtering shovel;
a fourth step, moving both the filtering shovel and the separating rod back a distance L2 along a moving direction in the second step, and then rotating the filtering shovel back to an initial position and stopping rotating the filtering shovel;
a fifth step, repeating the above second, third and fourth steps until the filtering shovel reaches a limit position thereof, and then rotating the filtering shovel to a horizontal position thereof, collecting all the clumped cat litter stacked on the upper layer of the un-clumped cat litter to the filtering shovel, and completing a filtration process of the clumped cat litter; and
a sixth step, moving the filtering shovel with the clumped cat litter back to a side of the collecting room, and continuing to rotate the filtering shovel until the clumped cat litter on the filtering shovel is transferred to the collecting room.

8. The filter method as claimed in claim 7, wherein an average length of the cat litter is less than the distance L1, the distance L1 less than 10 times of the average length of the cat litter, and the distance L2 less than the distance L1.

9. The filter method as claimed in claim 7, wherein a moving member drives both the filtering shovel and the separating rod to move along the length direction of the receiving room.

10. The filter method as claimed in claim 8, wherein the filtering shovel is driven by a rotating member that is installed on the moving member to turn over at both front and back ends thereof along the length direction of the receiving room.
